(19) United States
(12) Patent Application Publication
(10) Pub. No.: US 2019/0194510 A1
(43) Pub. Date: Jun. 27, 2019

(54) GLYOXALATED LIGNIN COMPOSITIONS

(71) Applicant: DOMTAR PAPER COMPANY, LLC, Fort Mill, SC (US)

(72) Inventors: Antonio PIZZI, Epinal (FR); Bruno MARCOCCIA, Oxford, OH (US); Shabnam SANAEI, Montreal (CA)

(21) Appl. No.: 16/331,340

(22) PCT Filed: Sep. 1, 2017
(86) PCT No.: PCT/IB2017/055282

§ 371 Date: Mar. 7, 2019

Related U.S. Application Data
(60) Provisional application No. 62/384,495, filed on Sep. 7, 2016.

(51) Int. Cl. C09J 197/00; C09J 161/12; C09J 11/06

(52) U.S. Cl. CPC C09J 197/005; C08K 5/1565; C09J 11/06; C09J 161/12

(57) ABSTRACT

This disclosure includes adhesive compositions comprising lignin, as well as methods of making such adhesive compositions, methods of making glyoxalated lignin or glyoxalating lignin-fiber mixtures, particularly glyoxalated kraft lignin, and methods of making lignocellulosic composite products including the present adhesive compositions.

This application claims the benefit of priority to U.S. Provisional Patent Application Ser. No. 62/384,495, filed Sep. 7, 2016, hereby incorporated by reference in its entirety.

### BACKGROUND

Various types of adhesives are used in the manufacture of lignocellulosic or wood composite products, which are generally formed of lignocellulosic material fragments or pieces that are bonded together using an adhesive. Such lignocellulosic material fragments or pieces may also be referred to as a substrate or substrates. The lignocellulosic material fragments or pieces used in such composite products can include, for example, wood chips, flakes, strands, and/or fibers. Such lignocellulosic material fragments or pieces are generally derived from the residue of milling operations, such as planer shavings, sawdust, plywood trimmings, and the like. Such milling residues may be further reduced to an appropriate or desired size prior to being formed into such composite products. The adhesive can be mixed, blended, sprayed, or otherwise contacted with the lignocellulosic material fragments or pieces to produce a composite substrate material. Such lignocellulosic composite products are generally formed by subjecting a mixture of the lignocellulosic material and adhesive to conditions that promote bonding between the lignocellulosic material and the adhesive to form the composite product in a desired form, such as, for example, a panel. For example, the adhesive can be at least partially cured by heating the composite substrate to produce the composite product or structure. Curing refers to the structural or morphological change that occurs in the adhesive when the composite substrate is subjected to conditions sufficient to cause the properties of an adhesive in the composite substrate to be altered, such as heating or pressing. Illustrative lignocellulosic composite products can include, but are not limited to, oriented strand boards, particleboards, structural timber, hard board, medium density board, engineered lumber, glued laminated timber, plywood, fiberboards, wafer boards, pressed wood, wood-based panels, veneers, and the like.

Conventional methods of forming lignocellulosic composite products typically employ for the adhesive either aminoresins or phenolic resins, both of which are typically thermosetting adhesive. Aminoresins are polymers produced by the reaction of an aldehyde with an amino or amido group containing adhesive, particularly urea and melamine. In nearly all aminoresins, the aldehyde component is formaldehyde. A major disadvantage of aminoresins is that they are not sufficiently water-resistant, and consequently are known to delaminate during use. Another drawback of aminoresins is that they are known to leach formaldehyde during slow water hydrolysis, in which the aminoresins break down due to reaction with water. The most common type of aminoresin is urea-formaldehyde resin. Phenolic resins are polymeric products of the reaction between an aldehyde and a phenolic hydroxyl group-containing compound. The phenolic component is oftentimes phenol, but may also be cresol, resorcinol, or catechol. Formaldehyde is the most common aldehyde component, although others such as glyoxal and furfural are occasionally used. The most common phenolic-resin adhesive is phenol-formaldehyde (PF) adhesive. Phenol and the other phenolic substances are considerably more expensive than urea, but typically maintain their seam lines in the presence of moisture, such that phenolic-resin adhesives are typically more water-resistant than aminoresin adhesives.

Phenol-formaldehyde (PF)-based resins (PF resin) is one example of a phenolic resin that has found wide use in adhesive for a variety of lignocellulosic composite products. Some such adhesives include only PF resin. Other such adhesives include a mixture of PF resin and MDI resin.

PF resins are typically prepared by reacting a molar excess of formaldehyde with phenol under alkaline reaction conditions. The resulting liquid PF resin is then spray-dried to produce the curable PF resin powder that is used as in adhesives. One drawback to the use of PF resins in an adhesive is that PF resins are petroleum-derived compounds and are thus subject to variations in price and limitations in production quantities. There is also an interest in reducing the amount of formaldehyde, both during the production of PF resins and in finished lignocellulosic composite products, due to environmental concerns associated with formaldehyde.

Compared to wood structural adhesives using other types of resins, adhesives using MDI resin typically have a lower polarity and a lower viscosity, and cure sufficiently at a relatively lower temperature even in the presence of a high level of water. These properties allow adhesives using MDI resin to rapidly penetrate into porous wood structures and form a strong seam line. A significant issue with the use of MDI resin is its high sensitivity to moisture and temperature. In many manufacturing processes, MDI resin suffers from significant premature polymerization (pre-cure) leading to substantial loss of resin efficiency and, hence, higher resin consumption. It is estimated that as much as 10% of the MDI may be lost to pre-curing leading to increased costs and decreased process efficiency.

Another component that is used in some resins is resorcinol, a polyhydric phenol. Of the phenolic resins, typically only those containing resorcinol are commercially important for adhesive applications that require room temperature setting or curing. The resorcinol-containing adhesives also have the advantage of being water-resistant and durable. However, the cost or resorcinol has restricted its use in many applications.

Another component that can be used in resin-based adhesives is lignin. Lignin is a wood-derived polyphenol polymer that is most commonly produced as a by-product from the well-known kraft wood pulping process, which may also be referred to in the art as the “kraft process” or “kraft pulping.” Typically, “black liquor” obtained from the kraft process is separated from the remaining wood pulp, and lignin is isolated from the black liquor by any of a number of methods known in the art. Adhesives can be prepared from this isolated or “crude” lignin by reacting the lignin with an MDI resin, PF resin and/or other aldehyde/phenol starting material to form a lignin-modified adhesive. However, crude lignin typically exhibits a low reactivity with these types of resins, and the cost advantage of substituting the more cost-effective lignin for a more-expensive phenol is lost due to the increase in processing time required for the lignin to react with the resin(s) and thereby produce the desired product.

Thus, there is a need for new adhesive compositions that can be made and/or used, such as use in making lignocellulosic composite products, with reduced amounts of environmentally unfriendly reactants.

### SUMMARY

Embodiments of the present invention are directed to adhesive compositions and methods of making such compositions. The present methods can reduce the amounts of formaldehyde produced or used during the production of adhesives and/or lignocellulosic composite products produced using the present adhesives. Similarly, the present adhesives can reduce the amount of formaldehyde produced or used during the production of lignocellulosic composite products

Certain embodiments of the present adhesive compositions that include a lignin component and one or more resin components. The lignin component of the present adhesive compositions can include a glyoxalated lignin or “GL”, a non-glyoxalated lignin, or a glyoxalated and non-glyoxalated lignin. A glyoxalated lignin is a lignin that is chemically modified with glyoxal, glyoxal is a non-volatile dialdehyde that is less reactive than formaldehyde and has the chemical formula of OCHCHO. A glyoxalated lignin can be identified by the amount of time the lignin was subjected to the glyoxalation reaction under defined conditions. Thus, a 15 minute glyoxalated kraft lignin differs from a 2 hour glyoxalated kraft lignin under similar conditions. The lignin can be, but is not limited to kraft lignin, lignosulfonates, organosolv lignin, soda lignin, hydrolytic lignin or any mixture thereof. Resins can include phenol-formaldehyde (PF) resins, methylene diphenyl diisocyanate (MDI) resins, tannins and tannin-based resins, resorcinol-formaldehyde (RF) resins, or combinations thereof. The resin component of the present adhesive compositions can include formaldehyde, or other aldehydes including glyoxal, furfural, furfuryl alcohol, hydroxymethyl furfural, glutaraldehyde, paraformaldehyde, formaldehyde yielding compounds, other formaldehyde based compounds, or other aldehydes.

The present adhesive compositions can also include a solvent. In the context of the present adhesive compositions, a solvent is a substance, particularly a liquid, that dissolves the lignin and resin components resulting in an adhesive solution. Examples of solvents include tetrahydrofuran (THF), methanol, and ethanol. Adhesives are substances applied to one or both of two separate surfaces to bind together and resist separation of the surfaces. A resin is a powdered or viscous substance that can be hardened.

In some of the present adhesive compositions, the lignin component makes up 10 to 80 percent by weight of the adhesive composition (“total weight percent”), the solvent makes up 0 to 50 percent by weight of the adhesive composition, and the resin component makes up 5 to 50 percent by weight of the adhesive composition. For example, the lignin component can be any one of, or between any two of: 10, 20, 30, 40, 50, 60, 70, and/or 80 total weight percent of the adhesive composition; the solvent can be any one of, or between any two of: 0, 10, 20, 30, 40, and/or 50 total weight percent of the adhesive composition; and the resin component can be any one of, or between any two of 5, 10, 20, 30, 40, and/or 50 total weight percent of the adhesive composition.

The lignin component can include glyoxalated lignin and, in some implementations, can also include non-glyoxalated lignin. In some embodiments, the lignin component can comprise 10 to 100 weight percent of glyoxalated lignin, and 90 to 0 weight percent of non-glyoxalated lignin. The glyoxalated lignin can be any one of, or between any two of: 0, 10, 20, 30, 40, 50, 60, 70, 80, 90, and/or 100 weight percent of the lignin component, and non-glyoxalated lignin can be any one of, or between any two of: 100, 90, 80, 70, 60, 50, 40, 30, 20, 10, and/or 0 weight percent of the lignin component. In some of the compositions the lignin component can be 100% non-glyoxalated lignin. The glyoxalated lignin can be a glyoxalated kraft lignin.

By way of example, a glyoxalated lignin can be mixed with non-glyoxalated lignin to form the lignin component of the present adhesive compositions. In particular ones of the present adhesive compositions, the lignin component is 50 to 70 weight percent glyoxalated lignin, and 30 to 50 weight percent non-glyoxalated lignin. In others of the present adhesive compositions, the lignin component is 100% glyoxalated lignin.

In some of the present adhesive compositions, the lignin component comprises glyoxalated lignin that has been glyoxalated for at most or about 10, 15, 20, 30, 60, 120, 150, 180, 210, 240, to 500 minutes. In particular ones of the present adhesive compositions, the glyoxalated lignin is glyoxalated for 5 to 15 minutes. The glyoxalated lignin can be obtained from kraft lignin and/or another type lignin.

In some of the present adhesive compositions, the glyoxalated lignin can be glyoxalated in the presence of fiber in order to control the glyoxalation process, that is a lignin-fiber mixture can be used as a glyoxalation reactant, as well as modify adhesive properties and reduce input costs. A lignin-fiber mixture can be glyoxalated for at most or about 10, 15, 20, 30, 60, 120, 150, 180, 210, 240, to 500 minutes. In particular ones of the present adhesive compositions, the lignin-fiber mixture has been glyoxalated for 5 to 15 minutes. In some such lignin-fiber compositions, the proportion of lignin to fiber by weight can be 95:5, 90:10, 80:20, 70:30, 60:40, 50:50, 40:60, 30:70, 20:80, 10:90, 5:95. In certain compositions the lignin to fiber ratio is between 60:40 and 50:50. The fiber can be a plant or wood. The fiber can be a chemically modified fiber.

Certain embodiments of the present adhesive compositions having a resin component that includes phenol formaldehyde (PF), methylene diphenyl diisocyanate (MDI), or a combination thereof (e.g., PF/MDI). The adhesive can include a resin component that can include MDI at or about 22 total weight percent and PF at or about 26 total weight percent (both resin components adding up to about 48 total weight percent), and glyoxalated lignin/lignin component at or about 52 total weight percent.

Others embodiments of the present adhesive compositions are a tannin-glyoxalated lignin adhesives. These tannin-glyoxalated lignin adhesive composition can include 10 to 90 total weight percent lignin component, and 90 to 10 total weight percent tannin solids. For example, the lignin component can be any one of, or between any two of: 10, 20, 30, 40, 50, 60, 70, 80, and/or 90 total weight percent of the adhesive composition, and the tannin solids can be any one of, or between any two of: 90, 80, 70, 60, 50, 40, 30, 20, and/or 10 total weight percent of the adhesive composition. In some such adhesive compositions, the lignin component is any one of, or between any two of: 20, 40, 60, 80, and/or 100% glyoxalated lignin. In some such adhesive compositions, the proportion of tannin solids to glyoxalated lignin by weight can be 80:20, 70:30, 60:40, 50:50, 40:60, 30:70, 20:80. In certain compositions the tannin solids to glyoxalated lignin ratio is between 60:40 and 50:50. Hexamine can be added to the tannin-glyoxalated adhesive at about 4, 5, 6, or 7 total weight percent. The glyoxalated lignin can be glyoxalated kraft lignin.

Other embodiments of the present adhesive compositions are lignin-resorcinol-formaldehyde adhesives. These lignin-resorcinol-formaldehyde adhesive compositions can include 10 to 90 total weight percent lignin component, and 90 to 10 total weight percent resorcinol-formaldehyde. For example, the lignin component can be any one of, or between any two of: 10, 20, 30, 40, 50, 60, 70, 80, and/or 90 total weight percent of the adhesive composition, and the resorcinol-formaldehyde can be any one of, or between any two of: 10, 20, 30, 40, 50, 60, 70, 80, to 90 total weight percent of the adhesive composition. The lignin component can be any one of, or between any two of: 0, 20, 40, 60, 80, and/or 100 weight percent glyoxalated lignin. In certain embodiments, the adhesive is 20 to 70 total weight percent resorcinol-formaldehyde.

The present adhesive compositions can be in the form of a dry powder, a paste, a liquid, or a suspension. A dry powder of the present adhesive compositions can, for example, have an average particle size of 40 μm to 100 μm. In liquid form, the viscosity of the present adhesive composition can be between 10 and 5000 centiposes (cps) at 20° C. For example, some of the present liquid adhesive compositions can have a viscosity of any one of, or between any two of: 50, 100, 200, 300, 400, 500 to 600, 700, 800, 900, and/or 1000 cps at 20° C. The viscosity of the adhesive can be modulated by controlling the degree or amount of glyoxalation of the lignin in the adhesive composition either by (i) using less glyoxal or (ii) mixing glyoxalated lignin with non-glyoxalated lignin or with lignin that is glyoxalated to a lesser degree (e.g., glyoxalation time of 10 to 120 minutes). In certain embodiments of the present adhesive compositions, the ratio of glyoxalated lignin to non-glyoxalated lignin between 7:3 and 1:1. The adhesives can be spray dried and/or acid precipitated.

This disclosure also includes methods of making glyoxalated lignin, particularly glyoxalated kraft lignin. In some of these methods, lignin is glyoxalated using a lignin glyoxalation reaction that includes dissolving lignin in a water/sodium hydroxide solution having a pH of at least 8 to form an alkaline lignin solution. The alkaline lignin solution can have a pH between 10 to 13, in some applications between 11 and 12. The alkaline lignin solution can be heated to a reaction temperature, stirring or mixing as needed. The reaction temperature can be any one of, or between any two of: 40, 50, 60, 70, 80, 90, and/or 100° C. In certain embodiments of the present methods, the reaction temperature is between 50° C. and 70° C., between 55° C. and 65° C., or equal to about 60° C. Once at or about a reaction temperature, a glyoxal solution is added to the alkaline lignin solution. The glyoxal solution can be an aqueous glyoxal solution, for example comprising any one of, or between any two of: 10, 20, 30, 40, and/or 50 weight percent glyoxal. In particular examples, the glyoxal solution is a 40 weight percent aqueous glyoxal solution. In particular embodiments of these methods, the glyoxal to lignin ratio is 1:1, 1:2, 1:3, 1:4, 1:6, 1:8, 1:10, or 1:13. The glyoxalation reaction is allowed to proceed for 10 to 500 minutes. For example, the glyoxalation reaction can be allowed to proceed for a period of time that is one of, or between any two of, 10, 30, 60, 120, 150, 180, 210, 240, 300, 400, and/or 500 minutes. In certain embodiments of these methods, non-glyoxalated lignin is mixed with the product of the glyoxalation process in order to adjust the level of glyoxalation. Lignin can be added at 5 to 50 total weight percent to the mixture of alkaline lignin solution and aqueous glyoxal solution at 20 to 500 minutes from the initiation of the glyoxalation reaction. For example, lignin can be added at any one of, or between any two of: 5, 10, 20, 30, 40, and/or 50 total weight percent; and/or can be added at a time that is one of, or between any two of: 10, 20, 30, 60, 120, 150, 180, 210, 240, 300, 400, and/or 500 minutes after initiation of the glyoxalation reaction. At a predetermined time, the glyoxalation reaction can be stopped by, for example, acidifying the reaction. If precipitation is not required then the reaction can be stopped, for example, by cooling the reaction. The reaction can be brought to a pH of about 4 or 5 by the addition of an acid, such as sulfuric acid. Once the reaction is acidified, the glyoxalated lignin can be precipitated and isolated by filtration, washed, and dried.

This disclosure also includes methods for making a lignin-resorcinol-formaldehyde adhesive. Some of these methods include: preparing a kraft lignin/tetrahydrofuran (THF) solution having about 29 total weight percent kraft lignin, about 58 total weight percent solvent (THF), and about 8 total weight percent HCl at 32% concentration, about 5 total weight percent paraformaldehyde powder, and about 5 total weight percent water at 60° C. Resorcinol in an aqueous solution of 19 to 23 weight percent resorcinol (in a ratio of about 40 parts resorcinol to 60 parts kraft lignin/THF solution) can then be added to the kraft lignin/tetrahydrofuran solution to form a kraft lignin/resorcinol mixture. The kraft lignin/resorcinol mixture can then be incubated at 25° C., and the pH of the kraft lignin/resorcinol mixture is adjusted to 9.5 to 11.25. The solids content can then be adjusted to a desired percentage by diluting the kraft lignin/resorcinol mixture in methanol.

Other embodiments of the present invention are discussed throughout this application. Any embodiment discussed with respect to one aspect of the invention applies to other embodiment of the invention as well and vice versa. Each embodiment described herein is understood to be embodiments of the invention that are applicable to all embodiments of the invention. It is contemplated that any embodiment discussed herein can be implemented with respect to any method or composition of the invention, and vice versa. Furthermore, compositions and kits of the invention can be used to achieve methods and compositions of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate plus or minus ten (10) percent of the recited value or values that define a range.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

### DESCRIPTION

Objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

The compositions described herein can be used as adhesive compositions in producing lignocellulosic or wood composite products. As described above, such lignocellulosic composite products can be formed by mixing lignocellulosic material fragments or pieces with an adhesive to form a mixture that can then be shaped into a composite substrate. In some of the present embodiments, this mixture and/or the composite substrate can have about 1 to about 20 weight percent adhesive composition, based on the combined weight of the lignocellulosic material and the adhesive. In some embodiments, the composite substrate can be heated to produce the composite product. For example, the composite substrate can be heated to a temperature between about 100° C. and about 250° C. The composite substrate can also be pressed when heated. For example, pressure can be applied to the composite substrate at a level of between about 15 to about 50 kg/cm², preferably between 25 and 45 kg/cm². The heat can be applied for between 3 and 25 seconds per mm thickness of the panel, preferably between 5 and 12 seconds per mm panel thickness.

In some embodiments, the present adhesive compositions can be applied by roller application, stripe application, spray application, foam extrusion, curtain application, dipping or their combination. The adhesive can be spread for a single glue line (sgl) in an amount between 80 grams per square meter (g/m²) to 540 g/m², depending for example on process parameters such as application method, wood species, thickness, quality, and structure of the wood panel. The present adhesive compositions can be applied in the form of powder, film, dispersion, colloid, liquid, aerosol or foam.

The present adhesive compositions include a lignin component that can, in turn, include a glyoxalated lignin. In some of the present methods, a lignin glyoxalation reaction includes the step of dissolving lignin in a water/sodium hydroxide solution having a pH of at least 8 to form an alkaline lignin solution. The alkaline lignin solution can have a pH between 10 to 13, or in some applications between 11 and 13. The alkaline lignin solution can be heated to a reaction temperature, stirring or mixing as needed. The reaction temperature can be any one of, or between any two of: 40, 50, 60, 70, 80, 90, and/or 100° C. In certain embodiments of the present methods, the reaction temperature is between 60° C. and 70° C., between 55° C. and 65° C., or about 60° C. Once at or about a reaction temperature, a glyoxal solution is added to the alkaline lignin solution. The glyoxal solution can be an aqueous glyoxal solution, for example comprising any one of, or between any two of: 10, 20, 30, 40, and/or 50 weight percent glyoxal. In particular examples, the glyoxal solution is a 40 weight percent aqueous glyoxal solution. In particular embodiments of these methods, the glyoxal to lignin ratio is 1:1, 1:2, 1:3, 1:4, 1:6, 1:8, 1:10, or 1:13. The glyoxalation reaction is allowed to proceed for 10 to 500 minutes. For example, the glyoxalation reaction can be allowed to proceed for a period of time that is one of, or between any two of, 10, 30, 60, 120, 150, 180, 210, 240, 300, 400, and/or 500 minutes. In certain embodiments of these methods, non-glyoxalated lignin is mixed with the product of the glyoxalation process in order to control the level of glyoxalation. Additional lignin can be added at 5 to 50 weight percent to the glyoxalation reaction at 20 to 500 minutes from the initiation of the glyoxalation reaction. For example, lignin can be added at any one of, or between any two of: 5, 10, 20, 30, 40, and/or 50 total weight percent; and/or can be added at a time that is one of, or between any two of, 10, 30, 60, 120, 150, 180, 210, 240, 300, 400, and/or 500 minutes after initiation of the glyoxalation reaction. At a predetermined time, the glyoxalation reaction is stopped by acidifying the reaction. The reaction can be brought to a pH of about 4 or 5 by the addition of an acid, such as sulfuric acid. Once the reaction is acidified, the glyoxalated lignin can be precipitated and isolated by filtration, washed, and dried. The dried glyoxalated lignin can be ground to a powder. Kraft lignin can be used as the lignin reactant in the glyoxalation process.

The glyoxalated lignin product can be dried by spray drying. Spray drying refers to the process of producing a particulate solid product from a liquid mixture. The process can include spraying or atomizing the liquid mixture into a temperature controlled gas stream to evaporate the liquid from the atomized droplets, and thereby produce a dry particulate solid. The temperature of the liquid mixture during the spray-drying process is usually about or greater than the boiling temperature of the liquid. An outlet air temperature of about 60° C. to about 160° C. is common. A dry particulate solid can contain less than any one of, or between any two of: 20, 15, 10, 5, 4, 3, and/or 2 weight percent of water. The dried solid can have a moisture maximum between 6 to 8 weight percent of water. In some embodiments, the present glyoxalated lignin solutions, can be diluted to a desired solids content, for example at or below about 15 weight percent solids content, before spray drying.

The present adhesive compositions can also include other components typically included in commercial adhesives. For example, other components can include corn flour, soy flour, wheat flour, nut shells, seed shells, fruit pits, bones, milwhite, clays, glasses, inorganic oxides such as silica and/or alumina, or any mixture thereof. The other components can be ground, crushed, pulverized, other otherwise reduced into particulate form and blended, mixed, or otherwise combined into or with the present adhesive compositions.

Certain embodiments of the present methods are directed to making a glyoxalated lignin adhesive composition. In one example, these methods can include preparing a lignin solution and reacting the lignin solution with paraformaldehyde powder at 60° C. Some of these methods can further include adding a resin base, such as PF, MDI, tannin, resorcinol or a combination thereof in an aqueous solution to the lignin solution, thereby forming a lignin/resin base mixture. The lignin/resin base mixture can then be incubated, and the pH of the lignin/resin base mixture adjusted to between 9.0 and 13.0. The solids content can then be adjusted to a desired percentage by diluting the lignin/resin base mixture in a solvent, such as methanol.

In certain embodiments, the glyoxalated lignin can be used to make a PF and MDI based adhesive. In certain embodiments a MDI:PF:glyoxalated lignin ratio by weight is 15-25%/20-30/45-55%. In particular embodiments the MDI/PF/glyoxalated lignin ratio by weight is 22%/26%/52%.

In certain embodiments of the present methods, a glyoxalated lignin component can be used to make an RF-based adhesive. The ratio of RF to lignin by weight can be 20-70%:80-30%. In some particular examples, the ratio of RF to glyoxalated lignin by weight is 40%:60%.

The following examples are included to demonstrate preferred embodiments of the invention. It should be appreciated by those of skill in the art that the techniques disclosed in the examples represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Glyoxalated Lignin (GL)

A glyoxalated lignin was prepared by slowly adding 295 parts by mass of a lignin powder (96% solid) to 384 parts by mass of water, while sodium hydroxide solution (30%) was added from time to time to keep the pH of the solution between 12 and 12.5 for better dissolution of the lignin powder. Dissolution of the lignin powder was also facilitated by vigorous stirring with an overhead stirrer. A total of 181 parts by mass of 30% sodium hydroxide aqueous solution were added which resulted in a final pH close to 12.5. A 2-liter flat-bottom flask equipped with a condenser, a thermometer, and a magnetic stir bar was charged with the above solution and heated to 60° C. A quantity of 175 parts by mass glyoxal (40 weight percent in water) was added, and the lignin solution was then continuously stirred with a magnetic stirrer/hot plate for 8 hours. The solids content for all glyoxalated lignins was around 31 weight percent. To ensure the stability of the resin, 69 parts by mass of 30 weight percent NaOH was added to the lignin solution in addition to 181 part of NaOH, after adding 21 weight percent glyoxal (40 weight percent in water), and the reaction of glyoxalated lignin was 2 hours. The solids content for all glyoxalated lignin was around 31.40 weight percent. The glyoxalated lignin preparation remained stable for more than 60 days.

### Example 2

### Characterization of Panels Using Different Adhesive Formulations

The Internal Bond (IB) Strength of Various Adhesive Formulations were Determined.

Internal bond strength is a fundamental measure of the adhesive performance in wood composites. The internal bond strength is in large part determined by the effectiveness of the glue application in the composite manufacture. Aluminum test blocks are glued to the top and bottom surfaces of a specimen. The test machine fixture grips the aluminum blocks and applies tension perpendicular to the specimen surface until the specimen fails. Internal bond strength is then reported as the maximum recorded load divided by the cross sectional area of the specimen. The European standard for dry IB is a minimum threshold of 0.35 N/mm² and, after swelling (immersion in boiling water for 2 hours), the minimum threshold is 0.15 N/mm².

Lignin Glyoxalation.

A lignin glyoxalation reaction was performed by dissolving 295 parts by mass of lignin in 477 parts of water containing 141 parts sodium hydroxide. Then 87.5 parts by mass glyoxal was added to this mixture, and the mixture then incubated at 60° C. for 10 or 15 minutes. The glyoxalated lignin solution was then diluted to around 15% solids content. The solution was then spray-dried and the glyoxalated lignin collected in powder form. The spray-dried powder of glyoxalated lignin was then dissolved back into water.

Glyoxalated Lignin Adhesive Compositions.

The glyoxalated lignin was used to make an adhesive using PF resin and MDI resin at different ratios. A ratio of MDI/PF/glyoxalated lignin by weight of 22%/26%/52% was selected for further tests.

The following tables provide particular examples of certain non-limiting embodiments of the invention. The following tables present the internal bond (IB) strength of the panels using different adhesive formulations. All formulations in Table 1, Table 2, Table 3, and Table 6 exceeded the dry IB threshold and were below the after swelling threshold. In Table 4, the 22% MDI/26% PF/52% GL having a 50:50 glyoxalated to non-glyoxalated mixture exceeded the dry threshold at 0.50 N/mm² and approached the swelling threshold at 0.13 N/mm². Table 5 shows that 22% MDI/26% PF/52% GL with a 70/30 glyoxalated to non-glyoxalated lignin exceeds the dry threshold and the after swelling threshold.

TABLE 1
Internal bond as a function of resin solids on dry wood

| | Dry IB at | IB after swelling |
|---|---|---|
| | 685 kg/m³ | at 685 kg/m³ |
| Panel | (N/mm²) | (N/mm²) |
| Panel: 22% MDI/26% PF/52% GL - | 0.66 | 0.10 |
| 15 min of reaction - | | |
| 10% of resin | | |
| Panel: 22% MDI/26% PF/52% GL - | 0.56 | 0.07 |
| 15 min of reaction - | | |
| 8% of resin | | |
| Panel: 22% MDI/26% PF/52% GL- | 0.53 | 0.07 |
| 15 min of reaction - | | |
| 7% of resin | | |

TABLE 2
Internal bond using spray dried glyoxalated lignin

| | Dry IB at | IB after swelling |
|---|---|---|
| | 685 kg/m³ | at 685 kg/m³ |
| Panel | (N/mm²) | (N/mm²) |
| Panel: 22% MDI/26% PF/52% GL- | 0.39 | 0.06 |
| 10 min of reaction - | | |
| spray drier | | |

TABLE 3
Internal bond using acidified glyoxalated lignin

| | Dry IB at | IB after swelling |
|---|---|---|
| | 685 kg/m³ | at 685 kg/m³ |
| Panel | (N/mm²) | (N/mm²) |
| Panel: 22% MDI/26% PF/52% GL- | 0.43 | 0.09 |
| 15 min of reaction - | | |
| acidified and dried | | |

TABLE 4
Internal bond using less glyoxal in glyoxalation

| | Dry IB at | IB after swelling |
|---|---|---|
| | 685 kg/m³ | at 685 kg/m³ |
| Panel | (N/mm²) | (N/mm²) |
| Panel: 22% MDI/26% PF/52% GL | 0.43 | 0.07 |
| 15 min of reaction - | | |
| half glyoxal | | |
| Panel: 22% MDI/26% PF/52% GL - | 0.50 | 0.13 |
| 15 min of reaction - | | |
| quarter of glyoxal | | |

TABLE 5
Internal bond using mix of glyoxalated lignin
and non-glyoxalated lignin in adhesive

| | Dry IB at | IB after swelling |
|---|---|---|
| | 685 kg/m³ | at 685 kg/m³ |
| Panel | (N/mm²) | (N/mm²) |
| Panel: 22% MDI/26% PF/52% GL | 0.71 | 0.16 |
| 15 min of reaction - | | |
| Mix of 70/30 | | |
| Panel: 22% MDI/26% PF/52% GL | 0.50 | 0.07 |
| 15 min of reaction - | | |
| Mix of 50/50 | | |

TABLE 6
Internal bond using glyoxalated lignin-fiber in adhesives

| | Dry IB at | IB after swelling |
|---|---|---|
| | 685 kg/m³ | at 685 kg/m³ |
| Panel | (N/mm²) | (N/mm²) |
| Panel: 22% MDI/26% PF/52% GL | 0.59 | 0.09 |
| 15 min of reaction | | |
| of lignin-fiber paste | | |

### Example 3

### Glyoxalated Lignin-Fiber Mixture

A lignin paste (lignin-fiber mixture, e.g., Domtar BIOCHOICE™ lignin and Domtar surface enhanced pulp fiber) was glyoxalated for 15 minutes as described in Example 1. Two panels with MDI/PF/Lignin of 22/26/52 were made. Before glyoxalation, the lignin paste was very viscous. After glyoxalation and cooling, the glyoxalated lignin paste was mixed with PF and MDI for panel preparation. The resin was not initially stable and required stabilization as described below.

Panels made with this formulation using the lignin paste initially passed the requirement for dry IB strength. After 2 hours in boiling water and drying the panels did not pass the requirement for IB strength.

TABLE 7
Internal bond using glyoxalated lignin adhesive

| | Dry IB at | IB after swelling |
|---|---|---|
| | 685 kg/m³ | at 685 kg/m³ |
| Panel | (N/mm²) | (N/mm²) |
| Panel: 22/26/52 - | 0.59 | 0.09 |
| 15 min of reaction of | | |
| kraft lignin paste | | |

Several systems are capable of stabilizing glyoxalated lignin while still yielding bonding results satisfying interior grade standards for particleboard. The great majority of these systems also provide a resistance to water that is superior to commercial interior grade adhesives. One of these approaches even surpassed the relevant standards for exterior grade particleboard (IB 0.15 N/mm²)). Among the successful systems are, not in any order of preference (i) spray-drying of lignin glyoxalated for 10 minutes, after which the soluble powder is stable; (ii) acid precipitation of lignin glyoxalated for 15 minutes, after which the soluble powder is stable; (iii) lignin glyoxalated for 15 minutes but with only ½ or ¼ of glyoxal, which resulting glyoxalated lignins are stable in liquid form for at least 9 days and longer; (iv) lignin glyoxalated for 15 minutes but mixed with non-glyoxalated lignin the proportions by weight of 70/30 and 50/50, with the 70/30 mixture satisfying exterior-grade stability standards.

### Example 4

### Tannin-Glyoxalated Lignin Adhesives

A second mixture included (i) a tannin extract solution to which 6% hexamine was added as hardener and (ii) the glyoxalated lignin solution made as described above. In respective variations, the proportion of tannin solids to glyoxalated lignin solids were 60:40 and 50:50 by weight. These tannin-glyoxalated lignin adhesives were then applied tested as described above to determine internal bond or “IB” strength. As shown in Table 8, all of these tannin-glyoxalated lignin adhesive formulations exceed the dry IB threshold.

TABLE 8
Internal bond using tannin-glyoxalated lignin adhesive

| | Dry IB (N/mm²) at |
|---|---|
| Panel | 700 kg/m³ and 7.5 min |
| Panel A: Tannin/hexamine + glyoxalated | 0.53 ± 0.07 |
| kraft lignin 60/40 | |
| 10% of resin | |
| 7.5 min of pressing time | |
| Panel B: Tannin/hexamine + glyoxalated | 0.44 ± 0.05 |
| kraft lignin 60/40 | |
| 8% of resin | |
| 7.5 min of pressing time | |
| Panel C: Tannin/hexamine + glyoxalated | 0.45 ± 0.04 |
| kraft lignin 50/50 | |
| 10% of resin | |
| 7.5 min of pressing time | |
| Panel D: Tannin/hexamine + glyoxalated | 0.42 ± 0.02 |
| kraft lignin 50/50 | |
| 8% of resin | |
| 7.5 min of pressing time | |

### Example 5

### Synthesis of Softwood Kraft Lignin/Formaldehyde/Resorcinol (LRF) Cold-Set Wood Adhesives

Beech strips were bonded with glue mix according to British standard BS (1204-1965) part 2 for close contact adhesive resins for wood, and cured for 7 days at 25° C. with 12% equilibrium moisture content.

### Experiment 1

The preparation of softwood kraft lignin/Formaldehyde/Resorcinol Cold-set wood adhesives (LRF-1) was according to Truter et al. Journal of Applied Polymer Science, 51:1319-22 (1994). 100 grams (g) of Kraft softwood lignin powder in 200 g tetrahydrofuran and 26.52 g of 32% HCl, were reacted with 17.76 g paraformaldehyde (96%) powder at 60° C. for 24 hours. Resorcinol in amounts of 52.8 g in 180 g water was added to the reaction mixture and reacted at 25° C. for 2 hours. The pH was adjusted to 6 using 40% NaOH solution. When the pH was adjusted to pH 6, sedimentation of LRF resin was observed and the tetrahydrofuran was evaporated in a rotary evaporator. When this method of synthesis was applied, a resin with high viscosity was obtained at the end of evaporation using the rotary evaporator, but the pH could not easily be adjusted to 9.5 because the resin was almost solid. So, methanol, in an amount of 30 total weight percent of the reaction volume, was added to decrease the viscosity but the resin was still very viscous. An additional 30 total weight percent of methanol was added but the resin was still very viscous. This result can be explained by sedimentation of lignin at pH 6 and the high molecular weight of the lignin.

### Experiment 2

In this experiment a LRF-2 was prepared by reacting 100 g of kraft softwood lignin powder in 200 g tetrahydrofuran and 26.52 g of 32% HCl, with 17.76 g paraformaldehyde (96%) powder at 60° C. for 24 hours. Resorcinol in an amount of 52.8 g in 180 g water was added to the reaction mixture and reacted at 25° C. for 2 hours. The pH was adjusted to pH 12 using 40% NaOH solution to increase the solubility of lignin and the tetrahydrofuran evaporated in a rotary evaporator. A very viscous resin-like plastic was obtained. Methanol, in an amount of 30 total weight percent of the reaction volume, was then added to decrease the viscosity, but it was very difficult to mix methanol with the LRF 2 resin and the resin was still very viscous.

### Experiment 3

In this experiment LRF-3 was prepared by reacting 100 g of kraft softwood lignin powder in 200 g tetrahydrofuran and 26.52 g of 32% HCl, with 17.76 g paraformaldehyde (96%) powder at 60° C. for 24 hours. Resorcinol in amounts of 52.8 g in 180 g water was added to the reaction mixture and reacted at 25° C. for 2 hours. The pH was 11.54. In this experiment, tetrahydrofuran was not evaporated. Afterwards the 2 hour reaction time, the solid contents and pot life (with the best pH) were determined as described below.

Determination of Solid Content of LRF Resin.

A clean container was placed in an oven at the test temperature (103±2° C.) for about 30 min and then allowed to cool in a desiccator for 15 min. The container was then weighed to the nearest 0.1 mg with M₁ being the mass in grams of the container. A test portion of 1 g to 5 g of adhesive was transferred into the container and the container then weighed to the nearest 0.1 mg with M₂ being the mass in grams of the container and test portion.

The container with test portion was then placed in the oven and dried at 103±2° C. for 3 hours. The container with test portion was then removed from the oven, cooled in a desiccator for 15 min, and weighed to the nearest 0.1 mg with M₃ being the mass in grams of the container and test portion after heating and cooling. The solid content was determined using the following formula:

$$C = \frac{{M}_{3} - {M}_{1}}{{M}_{2} - {M}_{1}} \times 100 \%$$

The solid content of LRF-3 resin was 33.95%.

Pot Life.

The time factor for pot life gives an indication of how fast the system is curing (progressing from a liquid state to a solid state). For this, three LRF-3 resin formulations were prepared each at a different pH, namely 9.40, 10.25 and 11.25. The pH was adjusted to 9.40, 10.25, and 11.25, respectively, using 33-weight percent NaOH solution. 9.64 g paraformaldehyde (96%) powder, 0.47 g olive stones flour filler (200 mesh), and 0.95 g wood flour filler (200 mesh) were added, respectively, to 33.95 g of each of the three LRF-3 formulations. The curing status was checked every 10 min. The pot life of different pH is shown in Table 9.

TABLE 9
Pot life

| pH | Pot life (hours) |
|---|---|
| 9.40 | 5.5 |
| 10.25 | 5 |
| 11.25 | 3 |

The best pH was pH 11.25 based on previous observations that a cold-set PRF resin should present a pot-life of between 2 and 2.5 hours. While 3 hours is slightly longer that desired, a higher pH is not desirable. Thus, 11.25 is the pH of resin used for the rest of the experiments.

Preparation of Glue-Mix and Laboratory Wood Test Specimens.

The resin glue-mix was composed of 28.39% fine paraformaldehyde powder added to the resins of LRF-3 at pH 11.25. The pH was adjusted to 11.25 with NaOH. The final resin mixture was spread on the surface of separate beech strips of dimensions 500×50×30 mm³ and these were then assembled to have a bonded overlap of 50×50 mm². Open assembly time and closed assembly time were each of 10 min. The samples were tested after being kept for 12 h in the hand clamp and after 7 days of ageing. Resistance to boiling water was determined by boiling the sample in hot water for 2 hours and then drying for 7 days at ambient temperature.

These samples were tested using an Instron model 4467 tensile tester with a crosshead speed of 2 mm/min. Average shear strength with 10 replications for each experimental unit was reported. Table 10 shows that the dry compression shear strength is approaching the standard threshold of 5 MPa. However, the value of compression shear strength is still less than the 5 MPa. This can be explained by the high viscosity of LRF-3 resin and the high molecular weight of the kraft lignin used for this method. For example, when viscosity is high, the adhesion of an adhesive to wood is typically reduced. An attempt was made to decrease viscosity by adding 30 total weight percent and 60 total weight percent of methanol (based on resin solids content) to LRF-3 resin to decrease and improve adhesion to wood. Dry shear strength increases when methanol is added to the LRF-3 resin. Tables 11 and 12 show that all dry compression shear strength results obtained with the LRF-3 resin with 30 total weight percent and 60 total weight percent methanol are higher than the minimum average acceptable value of 5 MPa. The best result is 10.63 MPa obtained after adding 30 total weight percent of methanol. Tables 11 and 12 shows that the boil water compression shear strength values are less than 5 MPa. However, the standard provides that the value is still acceptable if the percentage wood failure is 100% (reflecting wood weakness not adhesive weakness), which is the case here for the majority of the single samples tested. The increase in percentage wood failure after 2 hours in boiling water, tested wet, reflects another important effect, namely a moderate degree of undercure. As discussed above, the reactivity of lignin with resins is slightly lower as indicated by the pot-life being of 3 hours rather than 2 to 2.5 hours. The increase in methanol improves the mechanical properties under dry and humid conditions, indicating that the high viscosity of the resin induced poor wetting. When this constraint was eliminated, the results improved greatly. This decrease in dynamic viscosity of LRF-3 resin is appropriate to improve the adhesion of glue to the wood.

TABLE 10
Properties of LRF-3 resin and shear strength for beech wood strips

| Resin | LRF-3 |
|---|---|
| pH | 11.25 |
| Solid content (%) | 33.95 |
| Pot-life (hours) | 3 |
| Dry compression shear strength (MPa) | 4.67 ± 1.84 |
| Minimum value (MPa) | 3.9 |
| Maximum value (MPa) | 7.4 |

TABLE 11
Properties of LRF-3 resin with 30% methanol
and shear strength for beech wood strips

| | |
|---|---|
| Resin | LRF-3 + 30% methanol |
| pH | 11.25 |
| Solid content (%) | 33.95 |
| Dry compression shear strength | 8.56 ± 1.88 |
| (MPa) | Minimum value = 6.17 |
| | Maximum value = 10.63 |
| Dry wood failure (%) | 15 |
| 2 h boil water compression shear | 4.68 ± 1.36 |
| strength (MPa) | Minimum value = 3.39 |
| | Maximum value = 6.10 |
| Boiled wood failure (%) | 64 |
| | Minimum value = 35 |
| | Maximum value = 100 |

TABLE 12
Properties of LRF-3 resin with 60% methanol
and shear strength for beech wood strips

| | |
|---|---|
| Resin | LRF-3 + 60% methanol |
| pH | 11.25 |
| Solid content (%) | 33.95 |
| Dry compression shear strength | 7.29 ± 1.77 |
| (MPa) | Minimum value = 4.43 |
| | Maximum value = 9.07 |
| Dry wood failure (%) | 10 |
| 2 h boil water compression shear | 4.71 ± 1.36 |
| strength (MPa) | Minimum value = 3.50 |
| | Maximum value = 6.50 |
| Boiled wood failure (%) | 71 |
| | Minimum value = 42 |
| | Maximum value = 100 |

1. An adhesive composition comprising 10 to 80 total weight percent of a lignin component, 10 to 50 total weight percent of a solvent, and 5 to 60 total weight percent of a resin component.

2. The composition of claim 1, wherein the resin component is a methylene diphenyl diisocyanate (MDI), phenol-formaldehyde (PF), or a combination thereof.

3. The composition of claim 1, wherein the lignin component comprises an aldehyde modified lignin.

4. The composition of claim 3, wherein the aldehyde is glyoxal, furfural, furfuryl alcohol, hydroxymethyl furfural, or glutaraldehyde.

5. The composition of claim 1, wherein the lignin component comprises 10 to 100 weight percent glyoxalated lignin or glyoxalated lignin-fiber mixture.

6. The composition of claim 5, wherein the lignin has been glyoxalated for 10, 15, 20, 30, 60, 120, 150, 180, 210, 240, 300, to 500 minutes.

7. The composition of claim 5, wherein the glyoxalated lignin is glyoxalated kraft lignin.

8. The composition of claim 7, wherein the lignin has been glyoxalated for 15 minutes.

9. The composition of claim 1, wherein the lignin component comprises 50 to 70 weight percent glyoxalated lignin and 30 to 50 weight percent non-glyoxalated lignin

10. The composition of claim 1, wherein the composition has a viscosity of between 10 and 5000 cps.

11. The composition of claim 1, wherein the lignin component makes up 50 to 55 total weight percent of the composition, the resin component makes up 45 to 50 total weight percent of the composition, and the resin component comprises methylene diphenyl diisocyanate (MDI) at 20 to 25 total weight percent of the composition and phenol-formaldehyde at 20 to 30 total weight percent of the composition.

12. The composition of claim 11, wherein the lignin/MDI/PF ratio is 52%/22%/26% by weight.

13. The composition of claim 1, wherein the lignin component is 10 to 60 total weight percent of the composition, the resin component is 40 to 90 total weight percent of the composition, and the resin component is resorcinol-formaldehyde resin.

14. The composition of claim 1, wherein the composition is a dry powder.

15. The composition of claim 1, wherein the composition is a paste.

16. The composition of claim 1, wherein the composition is a liquid.

17. The composition of claim 1, wherein the composition is a suspension or solution.

18. A lignocellulosic composite comprising (i) 1 to 20 total weight percent of an adhesive composition of claim 1, and (ii) 80 to 99 total weight percent of a lignocellulosic material.

19. The lignocellulosic composite of claim 18, wherein the composite is an oriented strand board, particle board, structural timber, hard board, plywood, fiberboard, wood panel, or a veneer.

20. A process for making a tannin-glyoxalated lignin composition comprising:
(a) dissolving tannin in water to a 45 weight percent and adding NaOH to adjust the pH of the tannin solution to about 10;
(b) mixing the tannin solution with 6% hexamethylenetetramine (hexamine) and a glyoxalated lignin solution to form a tannin-glyoxalated lignin composition.

21. A tannin-glyoxalated lignin adhesive composition comprising 10 to 90 total weight percent lignin component and 10 to 90 total weight percent tannin solids.

22. The composition of claim 21, wherein the lignin component is 20, 40, 60, 80, to 100 weight percent glyoxalated lignin.

23. The composition of claim 21, wherein the proportion by weight of tannin solids to glyoxalated lignin solids is 80:20, 70:30, 60:40, 50:50, or 40:60.

24. The composition of claim 21, wherein tannin solids comprises 50 to 60 total weight percent of the composition.

25. The composition of claim 21, wherein the composition is a dry powder.

26. The composition of claim 21, wherein the composition is a paste.

27. The composition of claim 21, wherein the composition is a liquid.

28. The composition of claim 21, wherein the composition is a suspension or solution.

29. A cold-set lignin-resorcinol-formaldehyde adhesive comprising 10 to 80 total weight percent lignin component, 0 to 50 total weight percent solvent, and 5 to 70 total weight percent resorcinol-formaldehyde resin.

30. A composition comprising an adhesive of any of claims 1 to 29.

31. Use of an adhesive according to any of claims 1 to 29 as a binder for wood or other cellulosic material.

32. A method for glyoxalating kraft lignin or lignin-fiber mixture comprising:
dissolving kraft lignin or lignin-fiber mixture in an aqueous sodium hydroxide solution having a pH of between 8 and 13, thereby forming a kraft lignin solution;
adding an aqueous glyoxal solution of between 10 to 50% glyoxal to the kraft lignin solution, thereby forming a reaction mixture having a glyoxal-to-kraft lignin or glyoxal-to-lignin-fiber mixture ratio of 1:1 to 1:13;
incubating the reaction solution at between 40 to 100° C.

33. The method of claim 32, wherein the reaction solution in incubated for 5 to 500 minutes.

34. The method of claim 32, wherein the reaction is incubated at 50 to 70° C.

35. The method of claim 32, wherein the reaction mixture is incubated at about 60° C.

36. The method of claim 32, further comprising adding non-glyoxalated lignin to control the level of glyoxalation.

37. The method of claim 32, wherein isolating the glyoxalated kraft lignin is performed by filtering the lignin from the terminated reaction mixture, thereby forming a glyoxalated lignin retentate.

38. The method of claim 37, further comprising drying the glyoxalated lignin retentate.

39. The method of claim 38, wherein the glyoxalated lignin retentate is dried by spray drying.

40. A glyoxalated lignin composition produced by the method of claim 32.

41. The glyoxalated lignin of claim 40, wherein the composition comprises less than 10 total weight percent water.

42. A method for making a cold-set lignin-resorcinol-formaldehyde adhesive comprising
preparing a kraft lignin/tetrahydrofuran solution comprising about 30 total weight percent kraft lignin, about 60 total weight percent tetrahydrofuran (THF), and about 8 total weight percent HCl;
reacting the kraft lignin/tetrahydrofuran solution with approximately 5.5 weight percent paraformaldehyde powder relative to the kraft lignin/tetrahydrofuran solution at a temperature of 60° C. forming a kraft/lignin/paraformaldehyde product;
adding 12 to 16 weight percent of resorcinol relative to the kraft/lignin/paraformaldehyde product, thereby forming a kraft lignin/resorcinol mixture, and incubating the kraft lignin/resorcinol mixture at 25° C. and adjusting the pH to 9.5 to 11.25;
adjusting the solids content of the kraft lignin/resorcinol mixture to a desired percentage by diluting the kraft lignin/resorcinol mixture in methanol.

43. A cold-set lignin-resorcinol-formaldehyde adhesive made by the process of claim 42.

44. The cold set lignin-resorcinol-formaldehyde adhesive of claim 43, wherein the lignin component comprises 10 to 80 weight percent glyoxalated lignin.

45. The cold set lignin-resorcinol-formaldehyde adhesive of claim 44, further comprising a glyoxalated lignin-fiber mixture.

46. The cold set lignin-resorcinol-formaldehyde adhesive of claim 43, further comprising a lignin-fiber mixture.
